(19) United States
(12) Patent Application Publication
(10) Pub. No.: US 2014/0175225 A1
(43) Pub. Date: Jun. 26, 2014

(54) AIRCRAFT COCKPIT HAVING A LOWERED FLOOR FOR WALKING ON

(71) Applicant: Airbus Operations (SAS), Toulouse (FR)

(72) Inventors: Yves Durand, Aussonne (FR); Bernard Guering, Montrabe (FR)

(21) Appl. No.: 14/138,572

(22) Filed: Dec. 23, 2013

(30) Foreign Application Priority Data
Dec. 21, 2012 (FR) 1262585

(51) Int. Cl. B64D 11/00; B64D 43/00; B64C 1/14; B64C 1/18

(52) U.S. Cl. CPC B64D 11/00; B64C 1/18; B64D 43/00; B64C 1/1407
USPC 244/120; 244/129.6

(57) ABSTRACT

A cockpit for an aircraft nose, the cockpit having a floor that acts solely as a floor for the crew to walk on and that is lower than the height of the cabin floor situated behind the cockpit. The cockpit also has a stair connected to the floor in order to enter and leave the cockpit. This arrangement enlarges the volume of the cockpit and enables equipment to be housed therein that previously used to be housed in the zone that is difficult to access that is situated under the cockpit and that also contains the bay for storing landing gear.

### CROSS-REFERENCES TO RELATED APPLICATIONS

This application claims the benefit of the French patent application No. 1262585 filed on Dec. 21, 2012, the entire disclosures of which are incorporated herein by way of reference.

### BACKGROUND OF THE INVENTION

The invention relates to an aircraft cockpit and to an aircraft nose incorporating such a cockpit.

FIG. 1 shows a nose of a prior art aircraft 10, which nose includes a primary fuselage structure 12.

The primary structure 12 comprises in particular a plurality of fuselage frames 14 arranged parallel to one another along the longitudinal axis X of the nose. Only the top portions of the fuselage frames 14 are shown for reasons of clarity.

The structure 12 also has a bay 18 for storing the nose landing gear (not shown) of the aircraft.

The primary fuselage structure 12 defines a space inside the structure that is to be fitted out.

More particularly, a cabin floor 20 extends longitudinally from the rear end 10a of the nose to a radome zone 22 situated at the front end 10b of the nose.

The floor 20 subdivides the inside space for fitting out into an upper space and a lower space.

A zone dedicated to the cockpit 24 is for fitting out in the upper space above the landing gear bay 18.

A zone dedicated to an avionics bay 26 is arranged in the bottom space. This zone comprises a “front” zone 26a including the landing gear bay 18 (under the cockpit zone 24) and a “rear” zone 26b situated in part under the cockpit zone 24 and under the floor 20 of the top space 28 dedicated to a passenger cabin.

In the zone 26a, the space left free around the landing gear bay 18 presents a shape that varies both longitudinally (FIG. 1) and transversely, as can be seen in the cross-section of FIG. 2. Access to this small empty space is relatively difficult.

Integrating electrical and/or electronic equipment, systems, and avionics racks in such a zone is therefore found to be lengthy and tedious.

### SUMMARY OF THE INVENTION

The invention thus provides an aircraft cockpit, characterized in that it has a floor for walking on and at least one step that extends upwards from the floor for walking on.

The floor for walking on is thus lower than a floor for walking on in a conventional cockpit and relative to the cabin floor situated behind the cockpit along the longitudinal axis of the aircraft. The step or steps of a stair give access to enter or leave the cockpit via the cabin. The cabin is generally the cabin that is situated in line with the cockpit along the longitudinal axis of the aircraft. In commercial aircraft, it is generally a cabin dedicated to passengers.

This arrangement enlarges the inside volume of the cockpit compared with the volume in the prior art.

It is thus possible to integrate racks and (electrical and/or electronic, ventilation, . . . ) systems and equipment inside the cockpit that used previously to be housed around the landing gear bay in a zone that is difficult to access and that requires numerous connections with the cockpit. The mechanical and electrical links between the cockpit and the bottom zone situated under the cockpit are thus reduced and simplified considerably. The cockpit thus possesses a better coefficient of integration.

By increasing the size of the volume dedicated to the cockpit, this has the effect of reducing the volume that is situated underneath the cockpit and that is difficult to fit out.

The accessibility of equipment integrated in the enlarged volume of the cockpit is much better than when such equipment is arranged in locations that are small, such as for example in the lateral spaces situated between the lateral flanks of the landing gear bay and the skin or the frames of the fuselage.

This design of a cockpit incorporating in particular a floor for walking on and at least one step giving access to the cockpit (or from the cockpit) makes the cockpit easier to install in a primary fuselage structure.

According to one possible characteristic, the cockpit is made in the form of a cockpit module that is for integrating in a single operation in a primary fuselage structure of an aircraft nose.

Integrating the cockpit module in a single operation considerably facilitates the tasks of fitting out an aircraft nose on the final assembly line, and in particular it reduces the number of tasks to be performed. The time required for integration on the assembly line is thus greatly reduced.

According to one possible embodiment, the module comprises a plurality of elements fastened to one another so as to form an assembly that is suitable for being moved as a unit.

Thus, the cockpit module is made up of an assembly of elements (racks, electrical and/or electronic equipment, interconnection elements between these pieces of equipment, elements for ventilation systems, . . . ) that are connected or assembled together in such a manner as to obtain an assembly having mechanical cohesion that enables it to be manipulated as a single entity or object.

These various elements are arranged in an unchanging predetermined configuration that is the configuration they are to have when the prefitted module is integrated in a primary aircraft structure.

Thus, once the module has been integrated in the structure, all that remains to be done is to connect certain pieces of equipment and elements of systems together and to systems secured to the structure, and to add a few other pieces of equipment of the computer type in the module.

According to a possible characteristic, the floor for walking on does not perform a function of withstanding pressure. This arrangement is contrary to that of conventional cockpits. Conventional cockpits rest on a floor that has a structural portion connected to the primary fuselage structure in order to take up forces tending to deform the structure during pressurization.

The floor (which is thus not as thick as in the past) that is incorporated in the cockpit (whether or not it is in the form of a module) constitutes no more than a floor for walking on by the crew and in particular it no longer serves as a structural unit for supporting the various racks, pieces of electrical and/or electronic equipment, elements of ventilation systems, and other elements (pilot seats, . . . ) that make up such a cockpit.

The structural function of taking up forces via fuselage frames is thus performed by force-takeup elements that are independent and situated under the cockpit (whether or not the cockpit is in the form of a module).

According to various other possible characteristics taken in isolation or in combination with one another:
said at least one step and the floor for walking on define a central access passage of the cockpit;
the stair is mounted so as to be retractable;
the stair lies laterally between overpressure panels; the vertical faces of the stair may also comprise overpressure panels, for example;
the tread of a step is constituted by panels made of composite material and assembled together in such a manner as to be capable of being disassembled;
the cockpit module incorporates a plurality of racks receiving electrical and/or electronic equipment;
the cockpit module comprises two submodules arranged on either side of said at least one step and the floor for walking on;
each submodule includes at least one electrical and/or electronic rack receiving electrical and/or electronic equipment;
said at least one rack has a plurality of shelves arranged at different heights, each receiving electrical and/or electronic equipment, a “bottom” one of the shelves being arranged at the lowest height, the bottom shelf having a top face for receiving equipment on top and a bottom face having suspension members for suspending other equipment from the top of that equipment;
the bottom shelf extends longitudinally along the floor for walking on so as to impart an L-shape to said at least one rack;
each of the two submodules includes a rack having shelves arranged on one of the sides of the stair so that said stair lies between them;
the cockpit module includes elongate fastener elements for fastening each submodule to the primary fuselage structure;
each submodule incorporates elements that are designed to be suitable for performing a structural function of taking up the forces applied to the submodule;
the cockpit module includes a separation partition incorporating a secure door giving access to said module;
the separation partition is fastened to both submodules; this arrangement stiffens the assembly of the module, thus making it easier to hold while it is being handled; and
on either side of the secure door, the separation partition comprises panels that are assembled to one another via elongate assembly elements incorporating a structural function of taking up forces applied to each submodule.

The invention also provides an aircraft nose comprising a primary fuselage structure, the aircraft nose being characterized in that it includes an aircraft cockpit as mentioned above and a cabin floor arranged behind the cockpit along the longitudinal axis of the nose, the floor for walking on of the cockpit being situated at a height that is lower than the height of the cabin floor. Said at least one step thus extends upwards towards the cabin floor. The cabin is generally the cabin that is situated in line with the cockpit along the longitudinal axis of the nose. In commercial aircraft it generally comprises a cabin dedicated to passengers.

According to other possible characteristics taken in isolation or in combination with one another:
the primary fuselage structure comprises a plurality of fuselage frames arranged parallel to one another and spaced apart along the longitudinal axis of the nose, the nose including under the cockpit:
a bay for storing landing gear; and
for a plurality of fuselage frames, one or more connection elements suitable for working in traction and extending transversely between two opposite points of a given fuselage frame;
the landing gear storage bay has a plurality of reinforcing crossbeams arranged around it and each in the same cross-section as a fuselage frame, connection elements suitable for working in traction extending on either side of a reinforcing crossbeam in line with said crossbeam, with this applying to a plurality of reinforcing crossbeams arranged respectively in the same cross-sections as the plurality of fuselage frames in question; and
alternatively, the connection elements suitable for working in traction extend without interruption over the landing gear storage bay.

### BRIEF DESCRIPTION OF THE DRAWINGS

Other characteristics and advantages of the invention appear from the following description made by way of non-limiting illustrative example and with reference to the accompanying drawings, in which:

FIG. 1 (described above) is a general diagrammatic view in longitudinal section of a prior art aircraft nose;

FIG. 2 (described above) is a general diagrammatic view in cross-section of the FIG. 1 nose;

FIG. 3 is a general perspective view of a cockpit module in a first embodiment of the invention;

FIG. 4 is a general perspective view of the FIG. 3 cockpit module;

FIG. 5 is a diagrammatic view in longitudinal section of an aircraft nose incorporating the cockpit module of FIGS. 3 and 4;

FIG. 6 is a diagrammatic view in cross-section of the FIG. 5 aircraft nose;

FIGS. 7a and 7b are diagrammatic general views of the end partition portion 96 of FIG. 4;

FIG. 8 is a diagrammatic general view of the rack 68 of FIG. 4;

FIG. 9 is a diagrammatic general view showing the mechanical connection elements incorporated in the structural uprights of the racks 68 and 70 of FIGS. 3 and 4;

FIG. 10a is a detailed view on a larger scale in longitudinal section of the FIG. 5 aircraft nose;

FIG. 10b is a fragmentary view on a larger scale of the low shelf E6 of the rack 66 of FIG. 10a;

FIG. 11 is a general view on a larger scale showing the cockpit module being integrated in the FIG. 5 nose;

FIG. 12 is a diagrammatic view in cross-section of a variant embodiment of the FIG. 6 aircraft nose; and

FIG. 13 is a diagrammatic view in longitudinal section of an aircraft nose including a cockpit in a second embodiment of the invention.

### DETAILED DESCRIPTION OF THE PREFERRED EMBODIMENTS

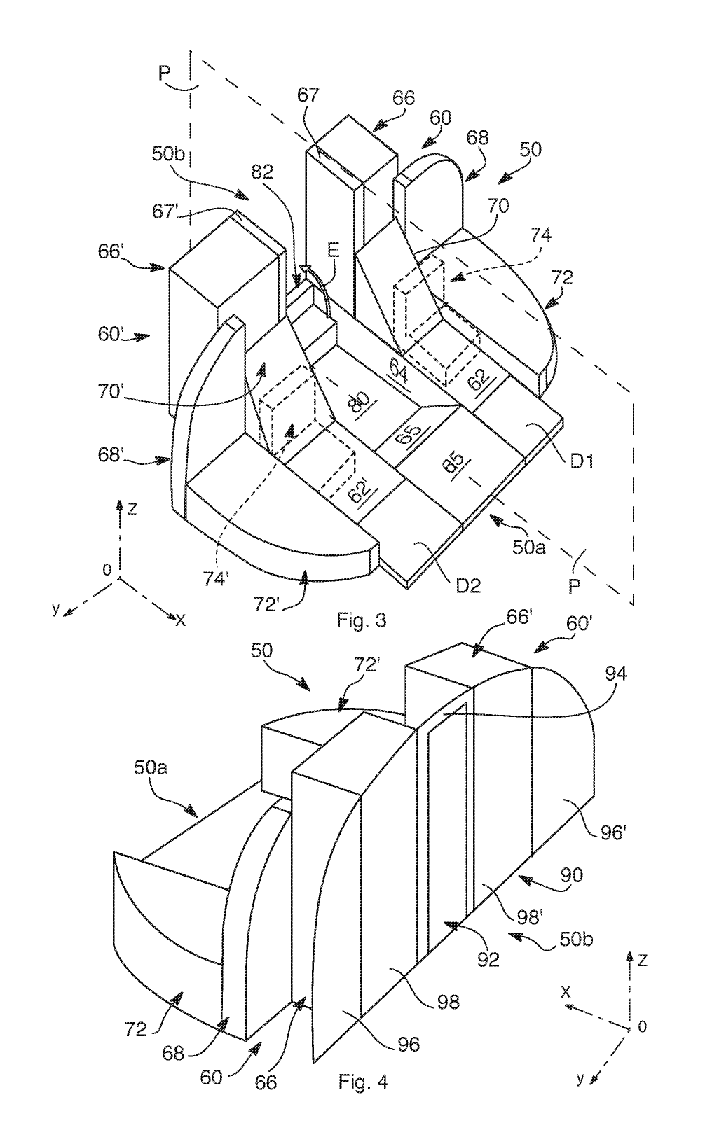

As shown in FIG. 3 and given overall reference 50, an aircraft cockpit is in the form of a cockpit module. The module comprises a cockpit structure made up of a plurality of parts or elements that are fastened/assembled together in such a manner as to constitute an assembly (physical entity or object) that is suitable for being moved as a unit and not part or element by part or element.

The elements assembled against one another provide the assembly with mechanical cohesion.

The elements constituting the module comprise racks for receiving electrical and/or electronic equipment, electrical connection elements (connectors, . . . ), electrical link elements (cables, . . . ), ventilation system elements such as ventilation ducts, valves, . . . , seats for the pilots, instrument panels, . . . .

All of these elements are integrated in the module while it is being built (away from the aircraft assembly line), thereby forming a re-equipped cockpit module that already includes most of the systems that provide the cockpit with its functionalities. Such a module considerably simplifies fitting out the nose of an aircraft and greatly reduces the time required for fitting out the nose, since most of the cockpit-fabrication tasks are performed beforehand.

The module 50 of FIG. 3 comprises two submodules 60 and 60′ that are arranged symmetrically on either side of a longitudinal vertical midplane P, also identified in the OXYZ geometrical frame of reference as the XOZ plane.

The axis X is the longitudinal axis of the module 50 and when the module is installed in the aircraft it coincides with the longitudinal axis of the aircraft fuselage.

The axis Y is the transverse axis along which the width of the module 50 extends (cross-section of the aircraft fuselage).

The axis Z is the vertical axis along which the height of the module 50 extends.

The two submodules 60, 60′ are spaced apart from each other by a floor for walking on 80 that extends longitudinally along the axis X and by an upward stair 82 in alignment with the floor.

The module 50 has two opposite ends, namely a front end 50a for positioning at the front end of an aircraft nose, and a rear end 50b set back from the front end of the nose.

The stair 82 is arranged at the rear end 50b of the module and gives access to the module and also makes it possible to leave the module. In a variant, the stair could comprise a single step or more than two steps, depending on the shape of the aircraft and on requirements.

In addition, the stair may be mounted between the two submodules so as to be retractable between a deployed position (FIG. 3) and a retracted position (e.g., raised towards the rear of the module along arrow E), thereby giving access to the zone situated under the module and at the rear thereof

The stair 82 and the floor for walking on 80 define a central passage giving access to the elements of the cockpit structure.

The floor for walking on 80 is made up of a plurality of panels of composite type that are assembled together so as to be capable of being disassembled.

More particularly, each module 60, 60′ includes a set of racks that are arranged and fastened against one another. The racks are arranged more particularly towards the rear of the cockpit structure and on its sides.

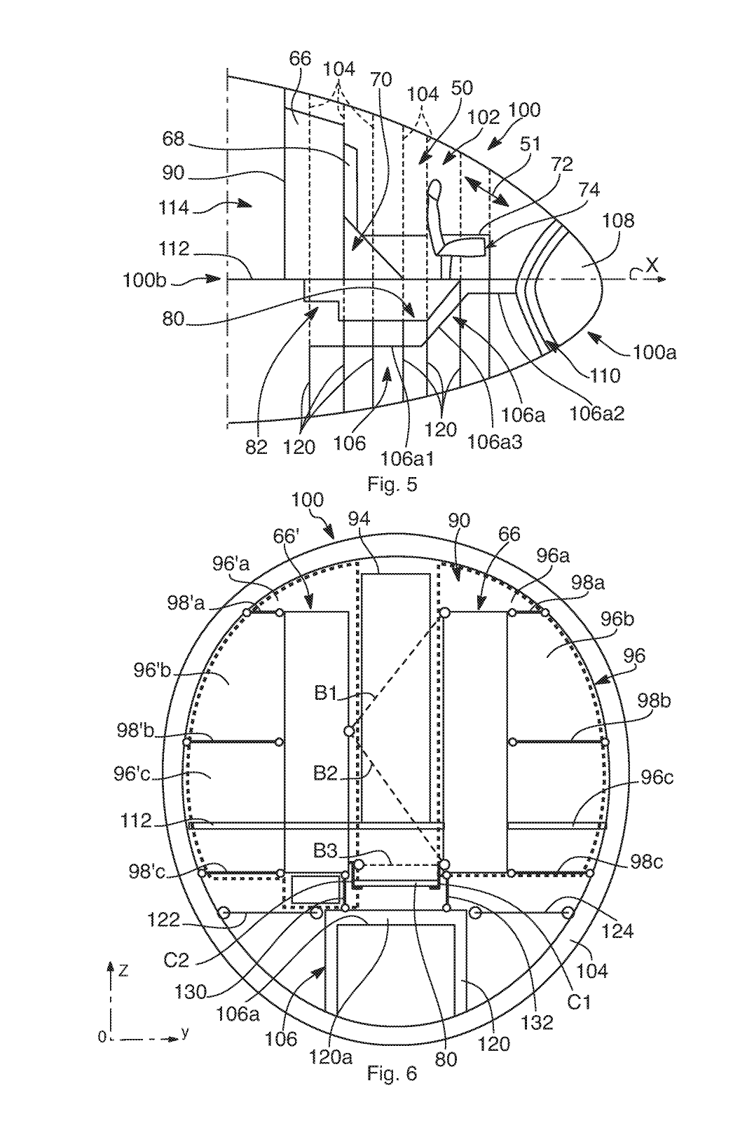

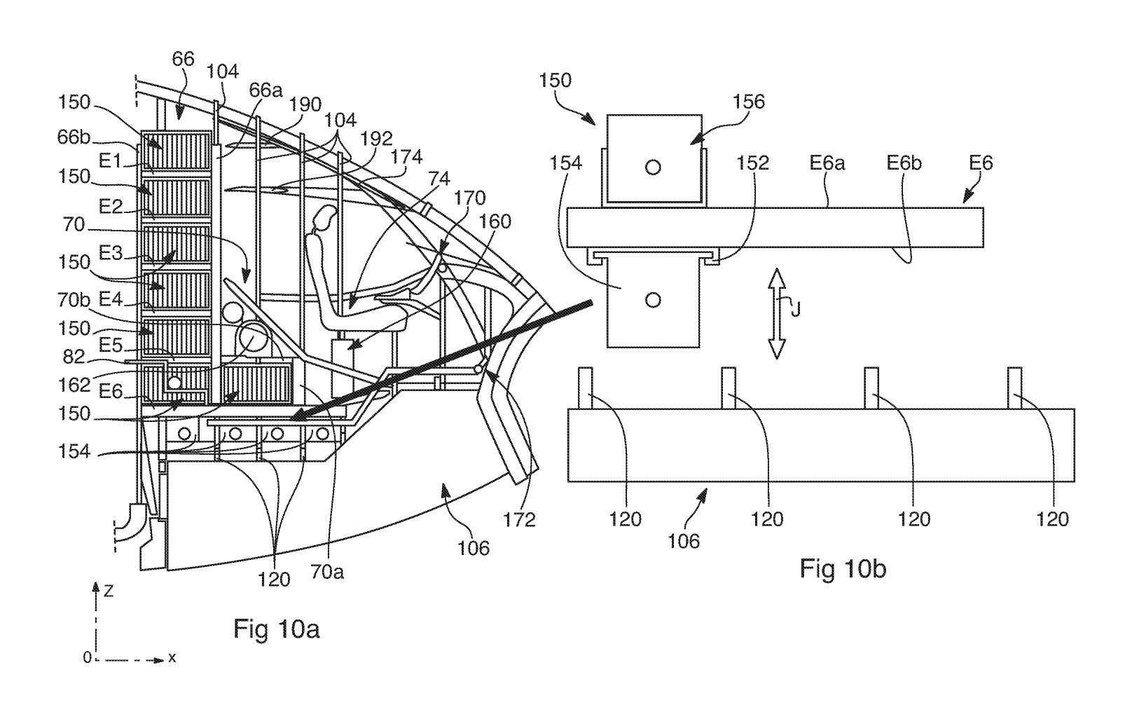

The submodule 60 is made up as follows (the description for the symmetrical submodule 60′ is identical, and identical elements are given the same references accompanied by the prime sign (′)):
a first rack 66 with shelves arranged at the rear of the submodule and extending mainly vertically (axis Z) over practically all of the available vertical space (FIG. 5) in the zone of the aircraft nose where the module is to be installed (this rack is described below in greater detail with reference with FIGS. 10a and 10b); this rack is arranged adjacent to the stair 82 so that the two modules 66 and 66′ are located on either side of the stair; it should be observed that in its portion facing the stair 82, this rack has a compartment that opens towards the stair and that acts, for example, as a locker;
a second rack 68 that is fastened against a portion of one of the (structural) vertical transverse uprights of the first rack 66 and that extends transversely towards the outside of the submodule going away from the first rack and from the floor for walking on 80;
a third rack 70 that backs onto the first rack 66 and that is adjacent to the second rack 68; the third rack 70 extends longitudinally (axis A) towards the front of the module and is generally wedge-shaped; and
a lateral fourth rack 72, also referred to as a side bench has its base fastened against a vertical transverse upright of the second rack 68 and against a longitudinal lateral upright of the third rack 70, and it extends towards longitudinally towards the front of the module.

The submodule 60 also has a pilot seat 74 arranged in line with the racks 66 and 70.

Trim panels are provided on all of the racks of the submodule. Trim panels are also provided to constitute a horizontal top panel 62 in alignment with the racks 66 and 70 and a vertical longitudinal panel 64 that runs along the stair and the floor for walking on.

It should be observed that the portion of the panel 64 that is against the stair 82 (and the portion of the corresponding panel 64′ of the opposite submodule) may constitute an overpressure panel. Such a panel helps to balance pressures on either side of the panel in the event of explosive decompression.

A trim panel 65 is placed longitudinally extending the floor for walking on 80. It is constituted by a half-panel extending obliquely upwards from the floor and by an upper half-panel that is horizontal and that extends towards the front of the module.

Two footrest panels D1 and D2 are arranged in alignment with the panels 62 and 62′ and constitute panels on which the pilots can rest their feet in the pedal zone.

FIG. 4 shows the cockpit module 50 in rear perspective.

The module also incorporates a vertical partition 90 (not shown in FIG. 3 for reasons of clarity) that extends transversely across the entire width in the transverse dimension of the module (axis Y).

This partition is fastened to both submodules 60, 60′, thereby contributing to stiffening the mechanical structure or framework of the module.

The partition 90 is formed by assembling a plurality of partition portions that extend in a cross-section (YOZ plane) on either side of a security door 92 giving access to the module.

The door 92 is surrounded by a door frame 94.

On either side of the door frame 94, the partition comprises:
an end first partition portion 96, 96′; and
an intermediate second partition portion 98, 98′ interposed between the partition portion 96, 96′ and one of the vertical uprights of the door frame 94.

The second partition portion 98 (or 98′) is fastened to the first rack 66 (or 66′) of the submodule 60 (or 60′), e.g., by screws.

The description below refers to figures showing the cockpit module in its environment for use, after it has been integrated in a primary fuselage structure of an aircraft nose.

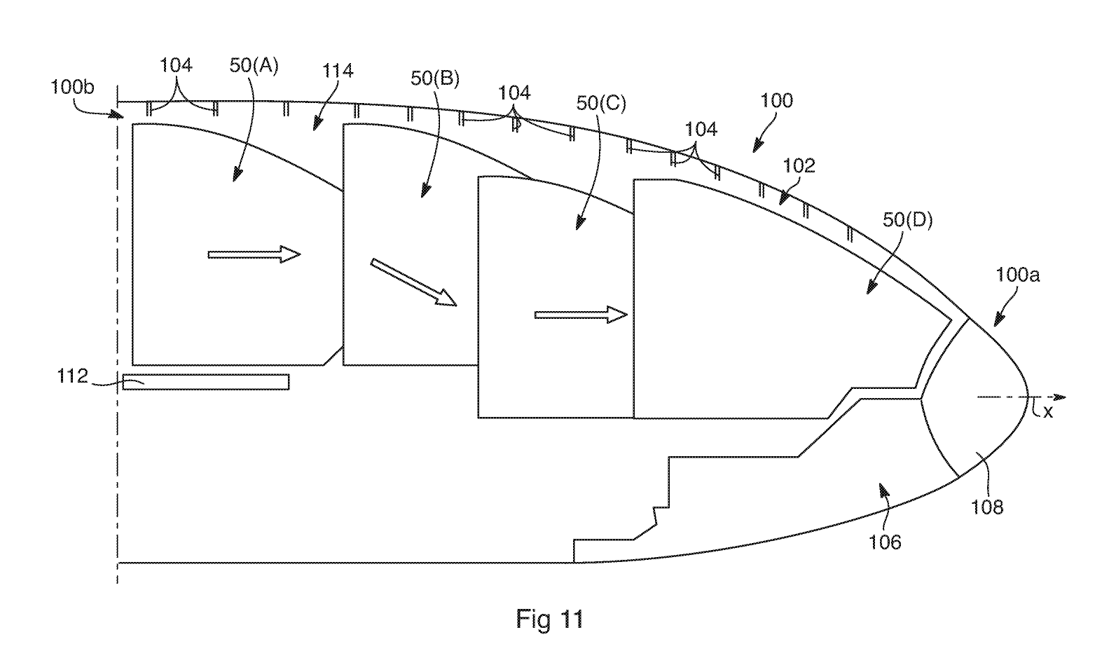

The method of integrating it is described further on with reference to FIG. 11.

FIG. 5 is a diagrammatic longitudinal section view of the cockpit module 50 of FIGS. 3 and 4 installed in an aircraft nose 100.

The nose 100 comprises a primary structure 102 that comprises in particular:
a plurality of mutually parallel fuselage frames 104 that are spaced apart longitudinally along the nose, along the longitudinal axis X of the nose (the frames are shown in part only and using dashed lines for reasons of clarity); and
a bay 106 for storing front landing gear (not shown) of the aircraft.

The nose 100 comprises firstly a front end 100a that receives a radome zone 108 defined by a radome partition 110, and secondly a rear end 100b that is open.

The nose 100 also has a cabin floor 112 (e.g., a floor of the passenger cabin) that extends as far as the partition 90 of the cockpit module 50, where the stair 82 is arranged.

As shown in FIG. 5, the floor for walking on 80 is lower than the cabin floor 112 of the cabin space 114. The stair 82 serves to step down from the greater height of the cabin floor 112 to the lower height of the cockpit floor 80, and vice versa.

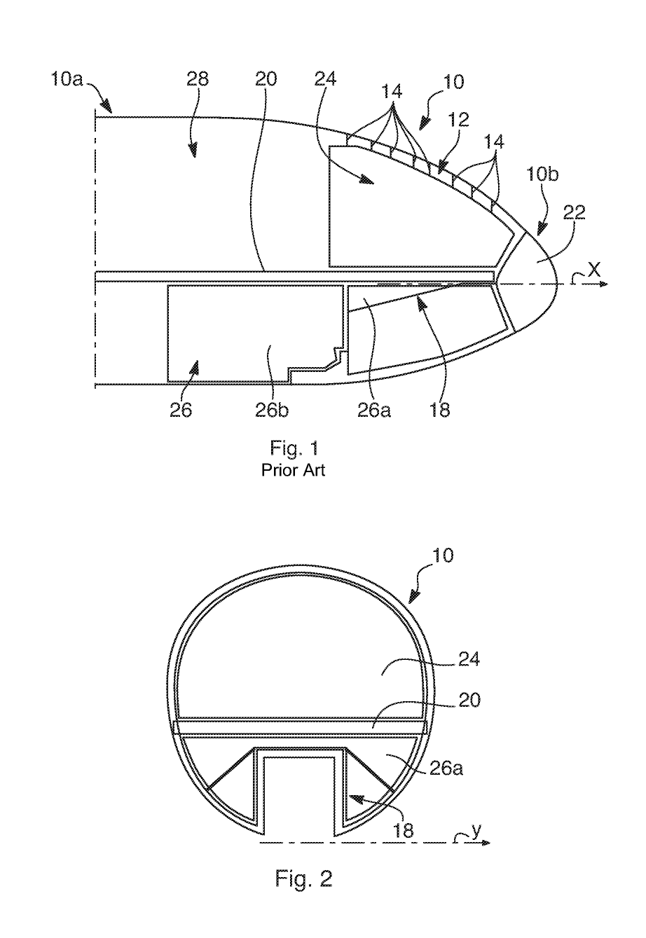

Having the floor for walking on 80 lower down than a conventional cockpit floor (FIGS. 1 and 2) serves to increase the internal volume of the cockpit.

The cockpit module 50 thus occupies a volume that is greater than the zone 24 dedicated to the cockpit in FIGS. 1 and 2.

It is thus possible to integrate more elements in the cockpit module than in a conventional cockpit, and in particular electrical and/or electronic equipment that previously used to be arranged under the cockpit in the zone 26a that is difficult to access. This serves to overcome, or at least to limit, difficulties involved with integrating equipment under the cockpit.

Integrating such equipment in the cockpit module considerably reduces and simplifies the mechanical, electrical, and ventilation links between the cockpit module and the underlying zone, and thus the tasks associated with putting such links into place.

Arrow 51 shows that it is possible to move various elements of the cockpit module forwards and parallel with the cockpit windshield, such as the pilot seats 74, 74′. This option is made possible by lowering the floor and by the greater vertical volume in the module.

It should be observed that lowering the floor for walking on in the cockpit module is made possible for example because of the generally staircase-shaped profile of the roof 106a of the landing gear bay 106.

The roof 106a has a horizontal lower wall 106a1 and a horizontal upper wall 106a2 that are separated from each other by an inclined wall 106a3 forming a riser.

This shape for the roof of the bay 106a is designed to fit as closely as possible to the shape of the nose landing gear (not shown) when it is in its folded position in the landing gear bay 106.

It should be observed that the floor for walking on 80 can be lowered in co-operation with other shapes (not shown) for the landing gear bay.

FIG. 6 is a cross-section view of the nose 100 of FIG. 5. In FIGS. 5 and 6, reinforcing crossbeams 120 (of generally upside-down U-shape) of the landing gear bay are shown mounted around the bay, on its lateral flanks and on its roof 106a.

Each of these crossbeams 120 has its bottom portion connected to the fuselage frame 104 that is arranged in the same cross-section as the crossbeam, as shown in FIG. 6.

Two horizontal transverse mechanical connection elements 122 and 124, such as rods, are each fastened at one end to a portion of the frame 104, and at the opposite end to a horizontal portion 120a of the reinforcing crossbeam 120.

These elements 122, 120a, and 124 in alignment are designed to work in traction. The element 120a can also work in bending since it takes up the load from the pressurized panels of the roof of the landing gear bay. Nevertheless, the elements 122 and 124 do not work in bending. This arrangement is provided for each crossbeam and the frame that is situated in the same cross-section.

This mechanical connection between the landing gear bay 106 and the fuselage frames 104 makes it possible to perform the function of taking up the mechanical forces exerted on the frames under the effect of pressurization.

This function of taking up forces is performed in the prior art by the structural portion of the cockpit floor (cross-members, . . . ).

Integrating this function in the landing gear bay 106 enables the cockpit floor to be simplified by reducing the floor in the cockpit module 50 to no more than a floor for walking on 80. The floor for walking on 80 therefore no longer incorporates the function of withstanding pressure as in the prior art.

As a result, the thickness of the cockpit floor is reduced.

It should be observed that the floor for walking on 80 no longer serves as a support for the various systems, pieces of equipment, and racks in the cockpit.

There follows a description of the elements for fastening the cockpit to the primary fuselage structure (frames, landing gear bay).

The cockpit module 50 incorporates elongate elements that are designed to be suitable for performing a structural function of taking up forces applied to each submodule.

Thus, each end partition portion 96, 96′ comprises a plurality of panels 96a, 96b, 96c, 96a′, 96b′, 96c′ that are vertically assembled together by elongate fastener elements.

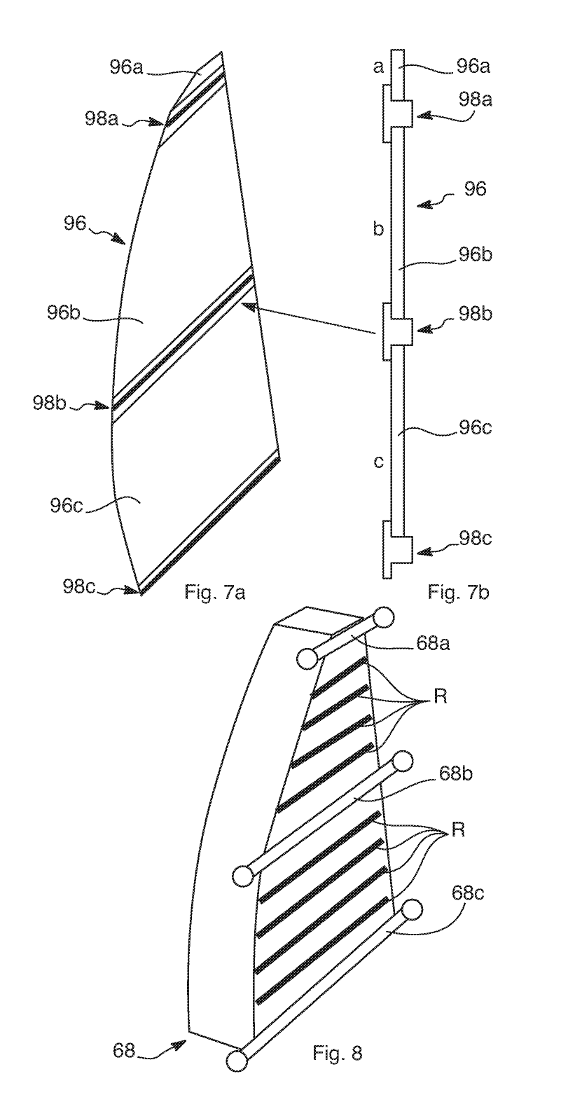

As shown in FIGS. 7a and 7b for the partition portion 96, two consecutive panels are assembled together by an elongate element such as a section member.

Thus, the three elements or section members 98a, 98b, 98d provide support for the panels 96a, 96b, 96c and also for rods for attaching the submodule 60 to the frame 104 of the primary fuselage structure (FIG. 6).

This partition portion incorporates part of the structural force-takeup function of the submodule.

As shown in FIG. 6, each of the racks 66, 66′ of the two submodules has its bottom portion mounted on reinforcing crossbeams 120 of the landing gear bay via fastener elements such as rods 130, 132.

The rack 68 of FIGS. 3 and 4 is shown diagrammatically in rear view in FIG. 8. The visible rear face of the rack is the face that appears in FIG. 4 and that is provided with a plurality of elongate strength members.

More particularly, there are two types of strength member:
firstly a type that performs a function of stiffening the back of the rack, these are section members R; and
secondly members of a second type that perform a function of stiffening the back of the rack and that also act as rods for attaching the submodule 60 to the frames 104 of the primary fuselage structure, these being section members 68a, 68b, 68c.

The rack 68 thus also performs part of the structural force-takeup function of the submodule. The reinforcing structure of the rack 68′ is identical.

It should be observed that the elongate structural force-takeup members incorporated in the rack 68 (or 68′) and in the end partition portion 96 (or 96′) are arranged horizontally in parallel cross-sections corresponding to the cross-sections of fuselage frames.

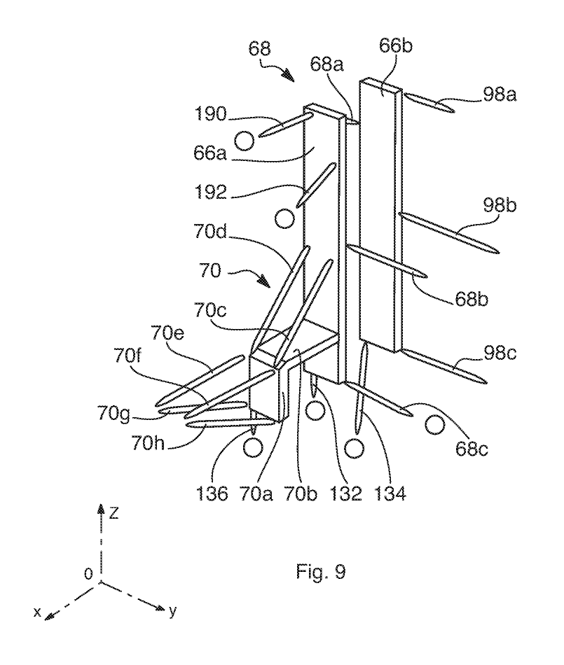

FIG. 9 is a very diagrammatic view of the structural uprights of the racks 68 and 70 of the submodule 60. The structure of the submodule 60′ is identical with the description below.

The first rack 68 having shelves comprises two vertical structural uprights 68a and 68b arranged transversely (axis Y) in the same cross-section of a fuselage frame. The shelves positioned horizontally between these uprights are not shown for reasons of clarity.

The strength members 98a-c of the end partition portion 96 (FIGS. 6 and 7a-b) engage with one of the two opposite edge faces of the uprights 66b, while the strength members 68a-c of the rack 68 (FIG. 8) engage with one of the two opposite edge faces of the upright 66a.

The fastener rod 132 of FIG. 6 is fastened to the upright 66a beneath it, while a second fastener rod 134 (FIG. 9) is fastened under the upright 66b.

This second rod has its opposite end mounted on a reinforcing crossbeam 120 of the landing gear bay, as does the first rod 132 in FIG. 6.

The rack 70 has a vertical structural upright 70a arranged transversely and a support plate 70b constituting a shelf and connecting the upright 70 to the upright 66a of the adjacent rack 68.

The rack 70 also has a set of elongate strength members that finish off its framework, such as rods.

More particularly, two mutually parallel elements 70c, 70d are arranged obliquely between the two structural uprights 70a and 66a of the racks so as to form a non-deformable triangle with the plate 70b and the upright 66a.

Two mutually parallel elements 70e and 70f are fastened to the top portion of the upright 70a and extend horizontally forwards (axis X) away from the upright 70a.

Two other mutually parallel elements 70g and 70h are fastened to the bottom portion of the upright 70a and extend obliquely forwards and upwards (XOZ plane), going away from the upright 70a so as to meet the free ends of the elements 70e, 70f. The arrangement of the four fastener elements 70e-h reproduces a triangular shape (non-deformable triangle).

These four fastener elements are for attaching to transverse fastener elements such as the rods 124 placed in alignment with the reinforcing crossbeams 120 (FIG. 6).

A third fastener rod 136 identical to the first rod 132 is fastened via one end under the upright 70a and via its opposite end on a reinforcing crossbeam of the landing gear bay.

FIGS. 10a and 10b show particular aspects of the rack 66 with shelves. These aspects are identical for the symmetrical racks 66′, which include redundant electrical and/or electronic systems and equipment, for example.

As shown in FIG. 10a, the rack 66 has a plurality of shelves E1 to E5 between its two vertical structural uprights 66a, 66b, which shelves are arranged one above another so as to constitute housings, which may be identical in size, for example.

These housings are designed to receive electrical and/or electronic systems and equipment, e.g., inserted by sliding in slideways extending transversely (axis Y) on the top faces of the shelves (slideway 156 in the fragmentary enlarged view of FIG. 10b).

The rack 66 of FIG. 10a is fitted (pre-equipped) with such systems and equipment 150 before being put into place inside the aircraft.

It should be observed that the rack 70 serves likewise to store this type of equipment in the housing arranged under the support plate 70b, between the two vertical uprights 66a and 70a.

At a height that is lower than the height of the shelves E1 to E5, the rack 66 also has a bottom shelf E6 that is arranged in part under the shelf E5 and that extends horizontally in the XOY plane towards the front end of the module. The bottom shelf E6 extends under the rack 70 and in part under the seat 74, thus making the rack generally L-shaped.

This shelf E6 is thicker than the other shelves since its strength needs to enable it to receive and support equipment on its top face E6a, and also to have other equipment hooked from its opposite bottom face E6b (FIG. 10b) i.e., it thus needs to support two sets of equipment.

For this purpose, suspension members 152 such as half-open section members are fastened to the bottom face E6b and extend transversely (axis Y) under the shelf These members act like slideways provided with flanges making it possible to slide thereon rim-forming portions of electrical and/or electronic equipment 154 for the purpose of suspending the equipment under the shelf It should be observed that the mechanical retention function of the half-open section member 152 ensures that the equipment 154 is held securely while it is being put into place.

The equipment 154 for suspending from the rack 66 is not mounted on the rack before it has been installed in the aircraft, unlike the major portion of the equipment.

As shown in FIG. 10a, when the equipment 154 is suspended there remains very little space available between the equipment and the underlying reinforcing crossbeams 120.

In order to install the cockpit module in the aircraft, it is useful to have space, in particular under the module, enabling it to be positioned and fastened to the primary fuselage structure (fuselage frames, landing gear bay crossbeams, . . . ).

Thus, in order to gain vertical mounting clearance J (represented by a double-headed arrow in FIG. 10b), the present embodiment provides for not pre-installing the suspended equipment 154 in the module before the module is in its final position in the aircraft.

However, the equipment 150 can be mounted in the top slideways 156 before the module is put into place.

The seats 74 and 74′ of the two submodules (FIG. 3) are each mounted on a respective mounting column that takes up the forces to which the seat is subjected.

This column 160 is shown in FIG. 10a. It extends through the wedge-shaped rack 70 via a passage formed through the oblique wall of FIG. 3. The column extends vertically down to the roof of the landing gear bay to which it is locked via a hinge (clevis and pin) that is not shown in FIG. 10a.

The various racks of the two submodules contain all of the electrical and/or electronic systems and equipment needed for providing the functionalities of the cockpit, where previously they used to be shared between the cockpit and the bottom zone containing the landing gear bay.

Nevertheless, certain isolated systems and pieces of equipment can still be located under the cockpit module for various reasons.

The racks 66 and 66′ receive the equipment 150, which may for example comprise the electrical master boxes (boxes controlling the electrical power coming from electricity sources on board the aircraft and constituting a kind of electricity management and distribution center) that used to be located under the cockpit, together with electrical equipment 154 associated with these master boxes (e.g., batteries, converters, voltage regulators, . . . ).

The equipment 150 of the rack 70 may for example comprise avionics computers that are installed after the cockpit module has been implanted in the aircraft, like the suspended equipment 154.

The transverse racks 68 and 68′ are likewise racks with shelves containing electrical and/or electronic equipment, such as circuit breakers.

The racks 70 and 70′ are so-called “oxygen” racks. In particular they contain a supply of oxygen for the crew in the form of an oxygen cylinder 162 (rack 70 in FIG. 10a) housed in the top portion of the rack, above the support plate 70b.

The lateral storage racks 72, 72′ are used for example to store the personal items of the pilots together with safety equipment (oxygen mask, extinguisher glove, service kit, . . . ). In the closed position, the top faces of these racks can act as supports (shelves) for various articles (beverages, meal trays, . . . ).

It should be observed that the cockpit module also has all of the links or link elements (cables, . . . ) between the pieces of electrical and/or electronic equipment in a given submodule and between submodules.

The module also includes (within a given submodule and between submodules) elements of the ventilation system (air ducts, couplings, . . . (not shown)) for the electrical and/or electronic equipment and for the crew.

Various elements referred to as “satellite” elements are also present in the module while it is being built, likewise for the purpose of saving time during the stage of integrating the module on the final assembly line.

These satellite elements are temporarily fastened using tooling made up of mainly of rods in a so-called “prepositioning” arrangement (close to their final positions) in order to allow the module to be mounted in the aircraft.

Once the module has been fastened to the primary fuselage structure, the tooling is removed and the satellite elements are then permanently fastened in their design positions.

By way of example, these satellite elements may be as follows (FIG. 10a):
the instrument panels 170;
the pedals 172;
the pilot seats 74, 74′ (for having their bottom ends locked onto the landing gear bay roof); and
all of the trim panels 174 of the cockpit.

FIG. 11 shows an implementation of a method of integrating the aircraft nose 100 that is shown in FIG. 5. Nevertheless, in FIG. 5, the module is shown integrated and the cabin floor 112 stops behind the cockpit module.

FIG. 11 shows that prior to the cockpit module 50 being integrated in the nose, the aircraft cabin floor 112 stops at a distance from the end 100a of the nose in order to leave a space extending longitudinally and vertically that is sufficient for passing the cockpit module 50 therethrough. By way of example, the distance is about twice the length of the module that is to be implanted. After integration, the floor is finished off so as to end up with the arrangement of FIG. 5.

Before transporting the module 50, tooling constituted mainly by rods is put into place between the two submodules in order to hold them firmly relative to each other.

By way of example, this tooling is shown in dashed lines in FIG. 6 comprising a set of hinged link rods B1, B2, B3 forming a triangulated frame connecting together the two submodules, e.g., connecting together the two structural uprights of the racks 66 and 66′.

As shown in FIG. 11, the cockpit module 50 is moved into the inside of the primary structure 102 until it reaches its reserved location situated over the landing gear bay 106.

For this purpose, a traveling crane (not shown) is put into place with its rails arranged inside the primary structure 102 in the top portion thereof. The rails are fastened to the fuselage frames 104 and they extend to above the reserved location.

The cockpit module 50 is attached by cables to wheels mounted on the rails of the traveling crane and it is inserted into the top space 114 via the open rear end 100b of the nose.

With the module 50 occupying the position 50(A) over the cabin floor 112, it is then moved in translation towards the front end 100a, as represented by the various arrows, while being kept apart from the floor and the top portions of the frames 104.

The movement in translation is substantially horizontal (along the longitudinal axis X) with a small vertical offset in order to go from the high intermediate position 50(B) to the low intermediate position 50(C) that is arranged facing the reserved location.

The transition to the final position 50(D) is performed merely by moving in horizontal translation.

Once the cockpit module 50 is installed in position above the landing gear bay 106, it is fastened to the primary structure 102 (frames 104 and bay 106) by a set of rods.

This set of rods comprises the rods integrated in the submodules, in particular for the submodule 60 (and identically for the submodule 60′), the rods 98a-c, 68a-c, 70e-h, and the external rods 132, 134, 136 and the rods 190, 192 (FIGS. 9 and 10a).

By using the assembly rods, the module 50 is fastened in isostatic manner to the primary fuselage structure, which gives rise to a fastening operation that is easier than it would be for an assembly of the type that is statically indeterminate.

Furthermore, by directly incorporating fastener elements (e.g., rods) in the racks and the various elements making up the module, the number of external fastener elements required is greatly reduced. This makes it simpler to fasten the module on the assembly line and thus reduces the overall time required for integrating it.

It should be observed that for reasons of ease of installation, and in particular in order to have access to underneath the cockpit module while it is being installed, the floor for walking on 80 need not be mounted on the module before it is installed.

After the cockpit module 50 has been put into place and fastened to the primary structure, the floor 80 and the stair 82 secured to the floor are fitted between the two submodules.

The floor 80 may for example be fastened by means of angle bars C1, C2 that are fastened longitudinally in spaced-apart manner on either side of the floor (FIG. 6).

Once the module 50 has been installed in the nose, the rack for receiving various pieces of equipment (for performing the functions that are performed by a conventional cockpit) and also most of those pieces of equipment (the amount of equipment that is to be incorporated in the module when it is still being determined in advance as a function of various criteria) are already integral portions of the structure of the module and therefore do not need to be installed. This gives rise to a great reduction in the time required for integration on the final assembly line.

The equipment in the module can subsequently be extended with certain pieces of electrical and/or electronic equipment (e.g., avionics computers) that are put into place on certain shelves of the racks.

The pieces of equipment added to the module are connected to one another and to the electrical and/or electronic systems and equipment (and indeed the ventilation systems element such as ducts, couplings, . . . ) that were already incorporated in the module. All of the necessary connections (electricity, air) inside the module between the various elements are pre-established before the module is installed, thus representing a considerable saving in time on the final assembly line. Thereafter, the module is fully connected to the electrical and/or electronic and ventilation systems provided on the primary fuselage structure of the aircraft via interface elements that are already presence in the module.

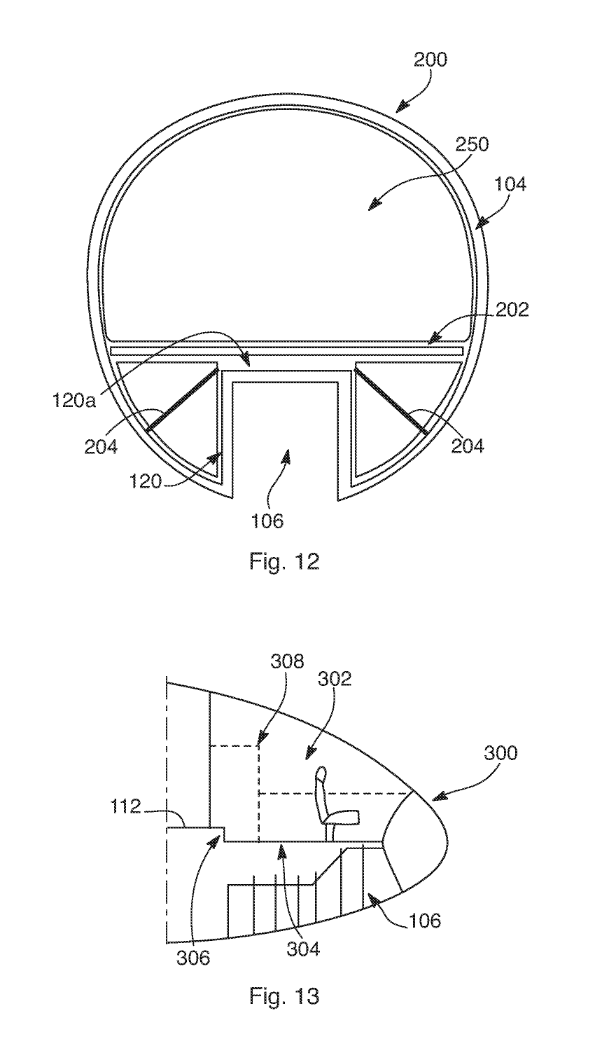

FIG. 12 shows a variant embodiment of the FIG. 6 nose.

The nose 200 of FIG. 12 is identical to the nose 100 concerning portions that are not described again below. Portions that are identical retain the same references.

In this variant, transverse mechanical connection elements 202 (e.g., cross-members) that are suitable for working in traction only extend horizontally without interruption over the landing gear bay 106 between two opposite points of a single frame 104. Oblique transverse rods 204 connect the reinforcing crossbeams to the frames 104.

Since these connection elements 202 do not work in bending, they can be smaller in height than conventional floor cross-members. This makes it possible to lower the floor for walking on in the cockpit module 250 compared with the height of the floor 20 in FIGS. 1 and 2. Since these elements 202 are above the crossbeams and not in alignment therewith, it is nevertheless not possible to lower the floor for walking on as much as in FIG. 6. The volume of the module 250 is thus increased to a lesser extent than the volume of the module 50. Nevertheless, its structure is substantially the same. For example, the racks 66 and 66′ are not so tall in the module 250 and the low shelves of these racks may be raised so that the suspended equipment does not interfere with the cross-members 202.

FIG. 13 shows a second embodiment of an aircraft nose 300 in which the aircraft cockpit is not made in the form of a module as described above. In this figure, only those elements that are modified compared with the preceding figures are given different references.

This aircraft cockpit 302 has a floor for walking on 304 that is lower than the cabin floor 112, thus making it possible to take advantage of all of the characteristics and advantages mentioned above when describing FIG. 5.

The cockpit also has a stair 306 for entering or leaving the cockpit. A shown, the stair has only one step. Nevertheless, depending on the shape of the space inside the aircraft and on requirements for integration, the stair could have more than one step.

The cockpit also has conventional racks and equipment 308 that are put into place element by element during the integration stage and not beforehand as in the first embodiment.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. An aircraft cockpit comprising:
a floor for walking on and
at least one step that extends upwards from the floor for walking on.

2. The aircraft cockpit according to claim 1, further comprising a cockpit module that is for integrating in a single operation in a primary fuselage structure of an aircraft nose.

3. The aircraft cockpit according to claim 2, wherein the module comprises a plurality of elements fastened to one another so as to form an assembly that is suitable for being moved as a unit.

4. The aircraft cockpit according to claim 2, wherein the floor for walking on is not constructed so as to be able to perform a function of withstanding pressure.

5. The aircraft cockpit according to claim 1, wherein said at least one step and the floor for walking on define a central access passage of the cockpit.

6. The aircraft cockpit according to claim 1, wherein the cockpit module incorporates a plurality of racks receiving at least one of electrical and electronic equipment.

7. The aircraft cockpit according to claim 1, wherein the cockpit module comprises two submodules arranged on either side of said at least one step and the floor for walking on.

8. The aircraft cockpit according to claim 7, wherein each submodule includes at least one rack receiving at least one of electrical and electronic equipment.

9. The aircraft cockpit according to claim 8, wherein said at least one rack has a plurality of shelves arranged at different heights, each receiving at least one of electrical and electronic equipment, a “bottom” one of the shelves being arranged at the lowest height, the bottom shelf having a top face for receiving equipment on top and a bottom face having suspension members for suspending other equipment from the top of that equipment.

10. The aircraft cockpit according to claim 9, wherein the bottom shelf extends longitudinally along the floor for walking on so as to impart an L-shape to said at least one rack.

11. The aircraft cockpit according to claim 7, wherein the cockpit module includes elongate fastener elements for fastening each submodule to the primary fuselage structure.

12. The aircraft cockpit according to claim 7, wherein each submodule incorporates elements that are designed to be suitable for performing a structural function of taking up the forces applied to the submodule.

13. The aircraft cockpit according to claim 2, wherein the cockpit module includes a separation partition incorporating a secure door giving access to said module.

14. An aircraft cockpit according to claim 7, wherein the cockpit module includes a separation partition incorporating a secure door giving access to said module, and wherein the separation partition is fastened to both submodules.

15. The aircraft cockpit according to claim 14, wherein, on either side of the secure door, the separation partition comprises panels that are assembled to one another via elongate assembly elements incorporating a structural function of taking up forces applied to each submodule.

16. An aircraft nose comprising a primary fuselage structure, the aircraft nose including an aircraft cockpit according to claim 1 and a cabin floor arranged behind the cockpit along the longitudinal axis of the nose, the floor for walking on of the cockpit being situated at a height that is lower than the height of the cabin floor.

17. The aircraft nose according to claim 16, wherein the primary fuselage structure comprises a plurality of fuselage frames arranged parallel to one another and spaced apart along the longitudinal axis of the nose, the nose including under the cockpit:
a bay for storing landing gear (106); and
for a plurality of fuselage frames, one or more connection elements suitable for working in traction and extending transversely between two opposite points of a given fuselage frame.

18. The aircraft nose according to claim 17, wherein the landing gear storage bay has a plurality of reinforcing crossbeams arranged around it and each in the same cross-section as a fuselage frame, connection elements suitable for working in traction extending on either side of a reinforcing crossbeam in line with said crossbeam, with this applying to a plurality of reinforcing crossbeams arranged respectively in the same cross-sections as the plurality of fuselage frames in question.

19. The aircraft nose according to claim 17, wherein the connection elements suitable for working in traction extend without interruption over the landing gear storage bay.
